(19) United States
(12) Patent Application Publication
(10) Pub. No.: US 2024/0310931 A1
(43) Pub. Date: Sep. 19, 2024

(54) INPUT DEVICE AND INFORMATION PROCESSING SYSTEM

(71) Applicant: LENOVO (SINGAPORE) PTE. LTD., SINGAPORE (SG)

(72) Inventors: Keiichi Yoshitomi, YOKOHAMA (JP); Mitsuhiro Yamazaki, YOKOHAMA (JP)

(73) Assignee: LENOVO (SINGAPORE) PTE. LTD., SINGAPORE (SG)

(21) Appl. No.: 18/542,760

(22) Filed: Dec. 17, 2023

(30) Foreign Application Priority Data
Mar. 13, 2023 (JP) 2023038365

(51) Int. Cl. G06F 3/0354; G06F 3/038; G06F 3/16

(52) U.S. Cl. CPC G06F 3/03545; G06F 3/0383; G06F 3/16

(57) ABSTRACT

An input device is a pen-shaped input device, and includes: a rod-shaped housing having a tip end and extending in an axial direction; a pen-tip section that protrudes from the tip end of the housing; a sound source disposed inside the housing; and a cavity having an opening at the tip end and extending along the axial direction of the housing, thus outputting sound generated by the sound source from the opening to outside of the housing.

### BACKGROUND OF THE INVENTION

### Field of the Invention

The present invention relates to a pen-shaped input device and to an information processing system including the input device and an information processing apparatus.

### Description of the Related Art

Information processing apparatuses such as laptop PCs, tablet PCs, and smartphones may be used with a pen-shaped input device for input operations to the touch screen. For instance, Japanese Unexamined Patent Application Publication No. 2022-187411 discloses a touch pen used for input to the touch panel, and the touch pen includes a vibration generator placed inside its rod-shaped housing.

### SUMMARY OF THE INVENTION

An input device including a vibration generator as described above is also called a haptic pen and has a tactile feedback function. Tactile feedback is used to improve the usability by generating vibrations in response to a contact with the touch screen that displays other information.

Note here that typical writing instruments such as pencils and ballpoint pens contribute to, in addition to vibrations, the sound generated during writing (writing sound) for better usability. Conventional input devices, however, do not take such writing sound into account.

In view of the problems of the conventional techniques, the present invention aims to provide an input device and an information processing system capable of improving the usability.

An input device according to the first aspect of the present invention is a pen-shaped input device, and includes: a rod-shaped housing having a tip end and extending in an axial direction; a pen-tip section that protrudes from the tip end of the housing; a sound source disposed inside the housing; and a cavity having an opening at the tip end and extending along the axial direction of the housing, thus outputting sound generated by the sound source from the opening to outside of the housing.

An information processing system according to the second aspect of the present invention includes: an information processing apparatus, and a pen-shaped input device. The input device includes: a rod-shaped housing having a tip end and extending in an axial direction; a pen-tip section that protrudes from the tip end of the housing; a sound source disposed inside the housing; and a cavity having an opening at the tip end and extending along the axial direction of the housing, thus outputting sound generated by the sound source from the opening to outside of the housing. The information processing apparatus includes a touchscreen that is operable in response to a touch with the pen-tip section of the input device. The opening faces a surface of the touchscreen during a touch operation to the touchscreen with the pen-tip section.

The above-described aspects of present invention improve the usability.

### BRIEF DESCRIPTION OF THE DRAWINGS

FIG. 1 is a schematic perspective view of an example configuration of an information processing system including an input device according to one embodiment.

FIG. 2 is a schematic cross-sectional view of the internal structure of the input device.

FIG. 3 is a front view of the tip end of the input device and its surroundings.

FIG. 4 is a front view of the tip end of the input device having a different-shaped cavity, and its surroundings.

FIG. 5 is a block diagram illustrating one example of the functional configuration of an information processing system according to one embodiment.

FIG. 6 schematically illustrates the input operation to the information processing apparatus using the input device.

FIG. 7 is a schematic cross-sectional view of the internal structure of an input device according to a modified example.

### DETAILED DESCRIPTION OF THE INVENTION

Referring to the drawings, the following describes an input device and an information processing system according to the present invention in details by way of a preferable embodiment.

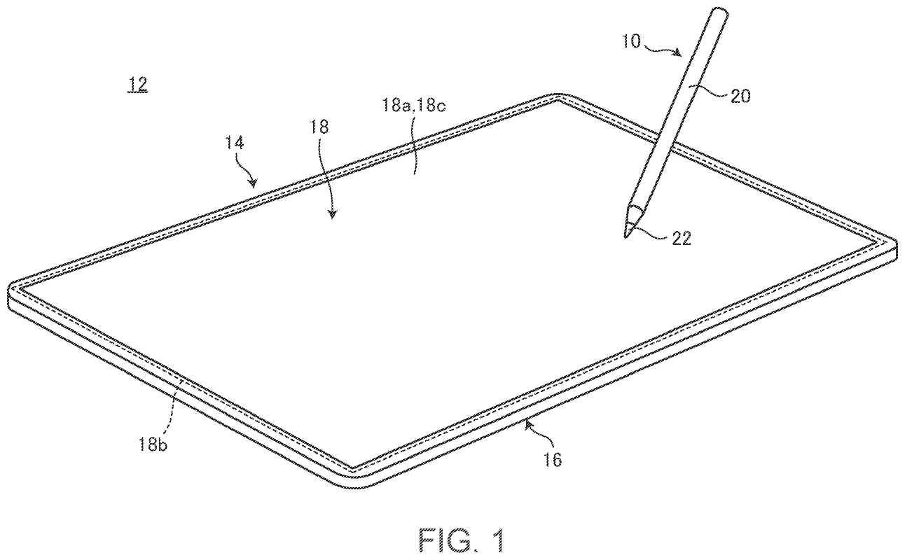

FIG. 1 is a schematic perspective view of an example configuration of an information processing system 12 including an input device 10 according to one embodiment. The input device 10 has a pen shape and is used for input operations to the information processing apparatus 14. The input device 10 is also called a digital pen, stylus, electronic pen, smart pen, or the like. The present embodiment exemplifies the information processing apparatus 14 that is a tablet terminal. The information processing apparatus, with which the input device 10 is to be used, can be other than a tablet device, such as a laptop PC or a smartphone.

The information processing apparatus 14 has a chassis 16 having a thin flat plate form, and a touchscreen 18 covering one face of the chassis 16. The chassis 16 internally accommodates various electronic components, such as a motherboard, on which the CPU and other processing devices are mounted, and a battery device.

The touchscreen 18 includes a display unit 18a and a touch sensor 18b. The display unit 18a includes liquid crystal, organic EL, or the like, and displays various types of information. The touch sensor 18b is superimposed on the surface of the display unit 18a. The touch sensor 18b is a touch panel capable of detecting input operations with the input device 10 on the surface 18c of the touchscreen 18. The information processing apparatus 14 is capable of monitoring the presence or not of an input operation, identifying the position where the input operation is detected, and executing data inputting or editing based on the input operation. For instance, the information processing apparatus 14 causes the display unit 18a to display the locus of the contact position where the input device 10 comes in contact with the touch sensor 18b.

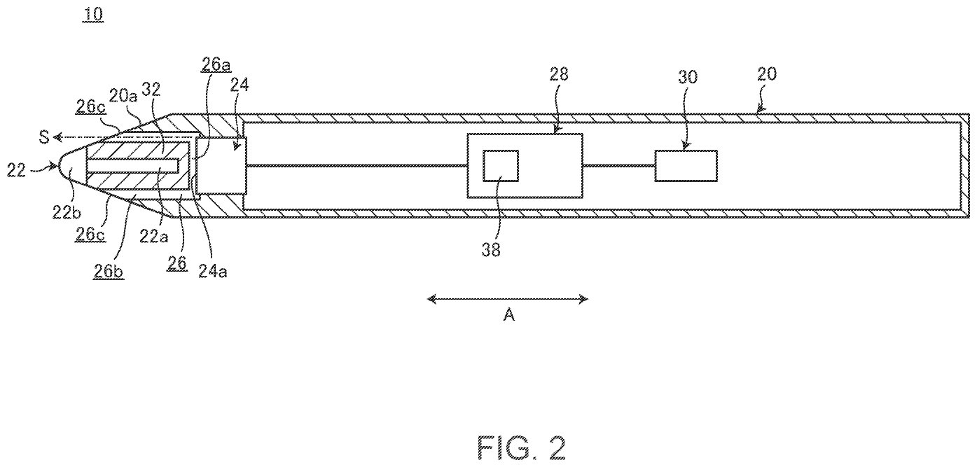

FIG. 2 is a schematic cross-sectional view of the internal structure of the input device 10.

A user holding the input device 10 moves the input device 10 while coming it in contact with the surface 18c of the touchscreen 18, whereby the user can use the input device 10 to input and edit data such as characters, symbols, and figures. As illustrated in FIG. 2, the input device 10 includes a housing 20, a pen-tip section 22, a sound source 24, a cavity 26, a circuit board 28, and a wireless communication unit 30. A battery device and others are further placed inside the housing 20 of the input device 10.

The housing 20 is a rod-shaped cylinder made of resin, wood, metal or other materials. The housing 20 can have various cross-sectional shapes, such as a perfect-circle or elliptical cylinder, or a rectangular cylinder. The housing 20 has a length and thickness suitable for being held by hand, similar to a writing instrument such as a pencil or a ballpoint pen.

The pen-tip section 22 is an input unit to the touchscreen 18. The pen-tip section 22 is configured to protrude from the tip end 20a of the housing 20. For instance, the tip end 20a has a truncated cone shape with a tapered shape. The shape of the tip end 20a is not limited to a tapered shape. The pen-tip section 22 protrudes from the center of the tip end 20a along the axial direction A of the housing 20. The axial direction A may also be referred to as the longitudinal direction of the housing 20. The pen-tip section 22 has a thin rod-shaped proximal end section 22a supported by a holder 32 within the housing 20, and a conical pen tip 22b exposed outside the housing 20. The holder 32 is a component that is supported internally near the tip end of the housing 20 and supports the pen-tip section 22 removably or non-removably.

The sound source 24 is supported on the inner peripheral surface of the housing 20 near the tip end. The sound source 24 generates a predetermined sound according to a drive signal sent from the information processing apparatus 14 via the circuit board 28. Preferably, the sound source 24 is placed so that its side face 24a facing the tip end in the axial direction A faces the cavity 26. The sound source 24 may include an actuator that generates vibrations, or may include a speaker. When the sound source 24 includes an actuator, it may be configured so as to vibrate a linear resonant actuator (LRA) along the axial direction A and transmit a sound signal from the side face 24a to the cavity 26. When the sound source 24 includes a speaker, it may include a cone placed on the side face 24a and may be configured to transmit a sound signal from the side face 24a to the cavity 26.

The cavity 26 has a first path 26a facing the sound source 24, a second path 26b extending along the axial direction A of the housing 20, and an opening 26c placed at the tip end 20a.

For instance, the first path 26a is a disc-shaped cavity having a radial direction in the cross-sectional direction of the housing 20 (direction orthogonal to the axial direction A). The first path 26a faces the side face 24a of the sound source 24. In other words, the side face 24a is part of the wall surface that defines the first path 26a.

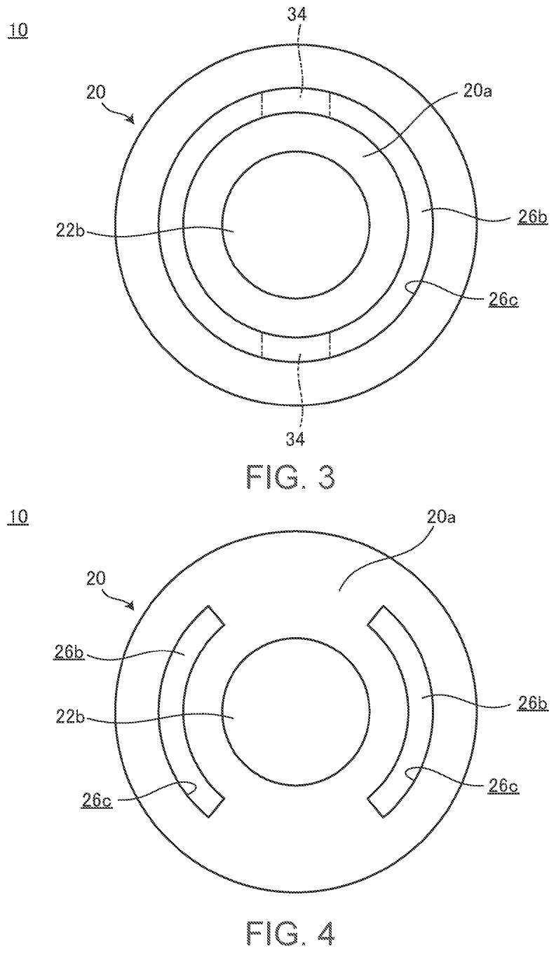

The second path 26b communicates with the first path 26a at its proximal end, and communicates with the outside of the housing 20 at its distal end via the opening 26c. For instance, the second path 26b is a doughnut-shaped space surrounding the proximal end section 22a of the pen-tip section 22 and the holder 32 (see also FIG. 3). The second path 26b does not have to surround the entire circumference of the proximal end section 22a and holder 32. For instance, as illustrated in FIG. 4, the second path 26b may be one or more arc-shaped spaces divided so as to partially surround the proximal end section 22a of the pen-tip section 22. The shape and arrangement of the second path 26b are not limited as long as it is a path that communicates between the first path 26a and the opening 26c. The opening 26c is a hole formed at the tip end 20a of the housing 20 and serves as an exit of the second path 26b.

Thus, the input device 10 is configured so that the cavity 26 communicates between the side face 24a of the sound source 24, which is the audio output face, and the outside of the housing 20. With this configuration, the input device 10 efficiently outputs the sound S generated by the sound source 24 from the tip end 20a through the cavity 26 (see the arrow S indicated by a dash-dotted line in FIG. 2).

As illustrated by the dash-double dotted line in FIG. 3, the second path 26b may be a donut-shaped space surrounding 360 degrees around the holder 32, and one or more bridges 34 may be provided to connect the holder 32 and the inner circumferential surface of the housing 20. This bridge (s) 34 improves the support strength of the holder 32 and the pen-tip section 22.

The circuit board 28 is supported within the housing 20. The circuit board 28 is a control board for the input device 10, and has a micro controller unit (MCU) 38 mounted thereon, for example. The MCU 38 is a processing device that comprehensively controls the functions of the input device 10. The MCU 38 includes a processor, memory such as ROM and RAM, and various input/output interfaces. The MCU 38 operates independently of the information processing apparatus 14.

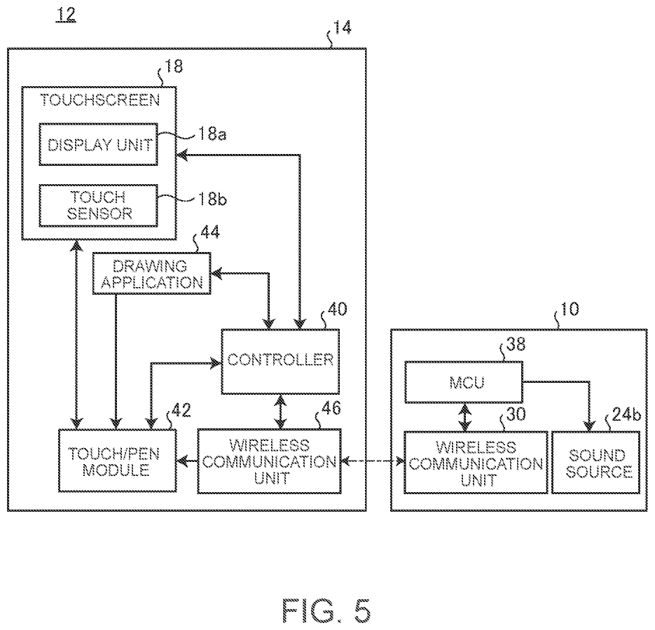

The wireless communication unit 30 is a wireless communication module that transmits and receives wireless data to and from a wireless communication unit 46 (see FIG. 5) of the information processing apparatus 14.

Next, the following describes an example of the functional configuration of the information processing system 12.

FIG. 5 is a block diagram illustrating one example of the functional configuration of the information processing system 12 according to one embodiment. As illustrated in FIG. 3, the information processing system 12 includes the information processing apparatus 14 and the input device 10.

The information processing apparatus 14 includes the touchscreen 18, a controller 40, a touch/pen module 42, a drawing application 44, and the wireless communication unit 46. The touchscreen 18 has the display unit 18a and the touch sensor 18b as described above.

The controller 40 comprehensively controls the functions of the information processing apparatus 14. The controller 40 may be implemented through the execution of a program by a processor such as a CPU (i.e., by software), or may be implemented by hardware, such as an integrated circuit (IC). The controller may be implemented by software and hardware. The controller 40 of this embodiment includes software such as an operating system (OS) and a processor such as a CPU.

The touch/pen module 42 cooperates with the controller 40 to control the touchscreen 18 and the input device 10. The touch/pen module 42 may be configured as a sub-card connected to a motherboard on which a CPU or the like is mounted, for example. The drawing application 44 is application software that controls the touchscreen 18 and input device 10 via the touch/pen module 42. The wireless communication unit 46 is a wireless communication module that transmits and receives wireless data to and from the wireless communication unit 30 of the input device 10.

The input device 10 includes the MCU 38, the wireless communication unit 30, and the sound source 24.

The MCU 38 receives sound control information from the information processing apparatus 14 using the wireless communication unit 30. For instance, the sound control information is information that lets the touch/pen module 42, which also cooperates with the controller 40, control the volume, frequency, and others of the sound (writing sound) generated by the sound source 24 during input operations to the touchscreen 18 with the input device 10. The MCU 38 uses this control information to synthesize a drive signal. The MCU 38 outputs the synthesized drive signal to the sound source 24. The sound source 24 is an actuator that generates vibrations or a speaker as described above. When the sound source 24 includes an actuator, the MCU 38 outputs a drive signal related to the vibration control as well as the sound control information.

Next, the following describes the input operations with the input device 10 and the advantageous effects.

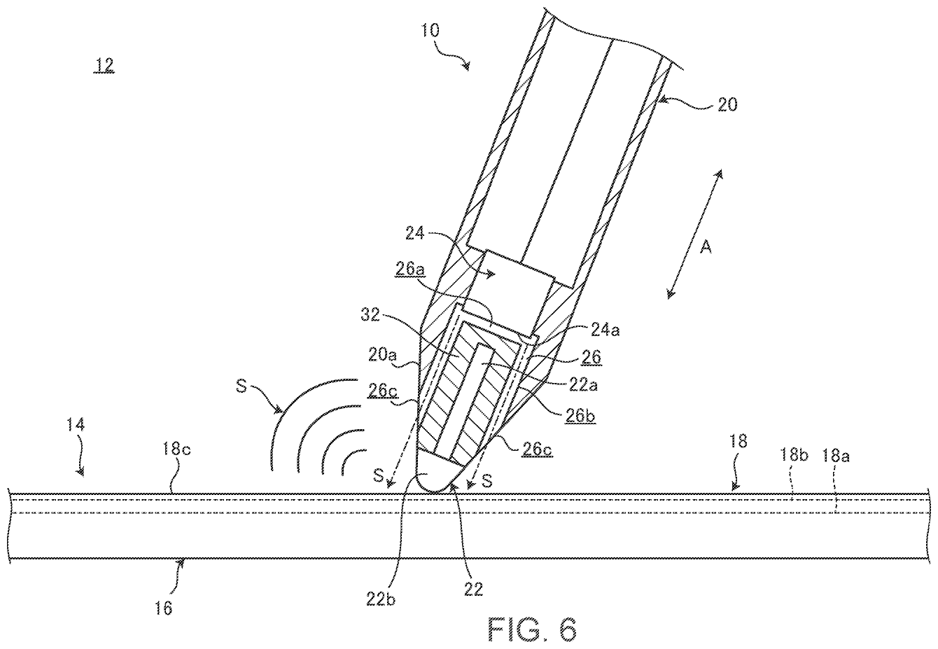

FIG. 6 schematically illustrates the input operation to the information processing apparatus 14 using the input device 10. As illustrated in FIG. 6, the input operation (touch operation) with the input device 10 moves the pen tip 22b in contact with the surface 18c of the touchscreen 18. The input device 10 then receives control information from the touch/pen module 42 through the drawing application 44 and controller 40. Based on this control signal, the input device 10 inputs a predetermined drive signal to the sound source 24 under the control of the MCU 48 to generate a predetermined sound.

The input device 10 of the present embodiment has the opening 26c at the tip end 20a of the rod-shaped housing 20, and has the cavity 26 that extends inside the housing 20 along the axial direction A and faces the sound source 24. That is, the cavity 26 has the opening 26c at the tip end 20a of the housing 20. Thus, the opening 26c is positioned opposite the surface 18c when the pen tip 22b is brought into contact with the touchscreen 18 (see FIG. 6). The cavity 26 also has the second path 26b continuous from the opening 26c, and the cavity 26 extends along the axial direction A and communicates with the sound source 24 via the first path 26a.

With this configuration, the sound S emitted by the sound source 24 efficiently passes through the cavity 26 to be output from the opening 26c to the outside of the housing 20. The sound S leaving the opening 26c is reflected by the surface 18c of the touchscreen 18 in the opposite position and diffuses into the surroundings, becoming loud enough for the user to perceive with their hearing. That is, the input device 10 outputs the sound generated by the sound source 24 inside the housing 20 as a sound wave, and causes it to collide with the surface 18c of the touchscreen 18. As a result, the user is allowed to perform a touch operation while listening to the sound S as a writing sound from the input device 10, and obtains a high usability similar to that of a writing instrument such as a pencil or a ballpoint pen. The input device 10 also has the advantage that, while the output of the sound source 24 is minimal, the cavity 26 increases the surface area of the sound path and generates a loud sound volume. Further, the input device 10 enables setting of the resonance frequency of the sound S to a desired frequency through the shape design of the cavity 26.

Moreover, the input device 10 has the opening 26c of the cavity 26 around the pen-tip section 22 (pen tip 22b). This allows the input device 10 to output the sound S from around the contact area to the touchscreen 18, and to output better writing sound without discomfort.

The input device 10 may be configured so that the writing sound is generated from a speaker of the information processing apparatus 14. In this case, however, although the speaker can produce sufficient volume, it is difficult to synchronize the position of the sound generation and the vibrations, which may cause discomfort to the user. In this respect, the input device 10 of the present embodiment has the advantage that the sound S is generated near the pen tip 22b, and thus the sound generation position is synchronized with the writing position, and the user obtains a high usability without any discomfort.

When the input device 10 includes the sound source 24 that is configured with an actuator generating vibrations, the housing 20 produces greater vibrations than with a speaker. This also has the advantage that, in addition to the sound S emitted from the vicinity of the pen tip 22b, the input device 10 also has an improved usability due to the vibrations directly transmitted from the sound source 24 to the fingertip. When an actuator is used as the sound source 24, the resonance frequency of the generated vibrations may be set to a frequency that cannot be felt by humans (e.g., 500 Hz or higher), so as to implement the control that gives a sense of use with only sound S. This control may be realized, for example, by switching a low-pass filter as needed, the low-pass filter being mounted on the circuit board 28 and cutting frequencies below 500 Hz under the control of the controller 40 of the information processing apparatus 14. In this way, the input device 10 is operable to give only writing sounds to users who are not comfortable with vibrations, while using an actuator as the sound source 24. This improves the versatility of the input device 10.

Note that conventional haptic pens are typically designed to improve the usability through tactile sensation by giving vibrations to the user, and do not have a structure such as the cavity 26 that outputs the sound generated by the vibrations. Therefore, the volume generated by the vibrations is small, and the conventional haptic pens fail to output loud enough to be perceived by the user as a writing sound. Even if a large vibration generates a large sound from inside the housing of a conventional haptic pen, the volume will fluctuate depending on the touch angle with the pen, resulting in uneven sound. This problem is especially noticeable with high-pitched sounds that are highly directional. In this regard, the input device 10 of the present embodiment is configured to let the sound S emitted from the opening 26c at the tip end 20a of the housing 20 collide with the surface 18c. Thus, problems such as sound unevenness due to the touch angle are less likely to occur in the input device 10.

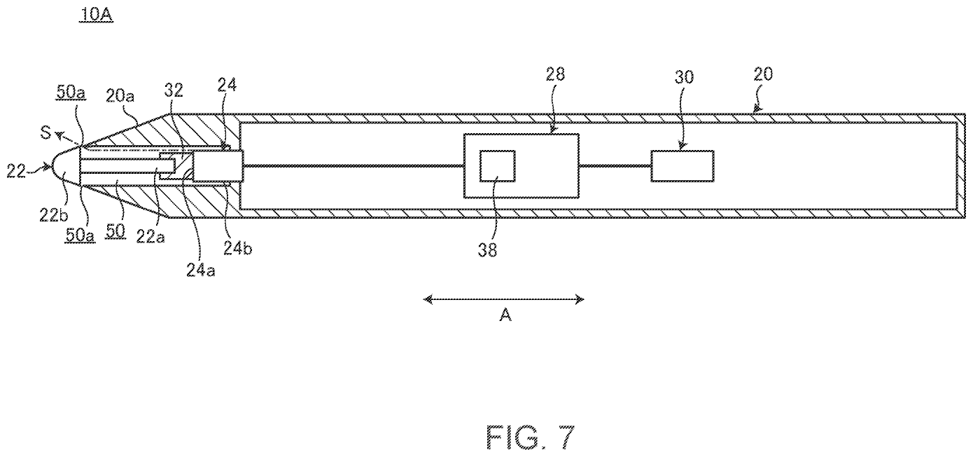

FIG. 7 is a schematic cross-sectional view of the internal structure of an input device 10A according to a modified example. In FIG. 7, like reference numerals indicate like parts having the same or similar configurations in FIGS. 1 through 6 and thus the same functions and advantageous effects, and their detailed description is omitted.

The input device 10A illustrated in FIG. 7 includes a cavity 50 having a different configuration from the cavity 26 of the input device 10 illustrated in FIG. 2. The input device 10A has a gap between the insertion hole for inserting the proximal end section 22a of the pen-tip section 22 into the housing 20 and the proximal end section 22a, and this cavity 50 is formed by widening this gap. The opening 50a of the cavity 50 is the gap formed between the pen tip 22b of the pen-tip section 22 and the insertion hole 52, or the gap that is slightly widened. This cavity 50 also extends along the axial direction A and faces the sound source 24 at the back of the hole. Note that the sound source 24 in this configuration is preferably placed so that the outer circumferential surface 24b facing the cavity 50 serves as the audio output surface. The input device 10A also outputs sound S without discomfort similar to the input device 10 described above, so that it improves the usability.

The present invention is not limited to the above-described embodiments, and can be modified freely without deviating from the scope of the present invention.

1. A pen-shaped input device comprising:
a rod-shaped housing having a tip end and extending in an axial direction;
a pen-tip section that protrudes from the tip end of the housing;
a sound source inside the housing; and
a cavity having an opening at the tip end and extending along the axial direction of the housing, whereby the cavity outputs sound generated by the sound source from the opening to outside of the housing.

2. The input device according to claim 1, wherein
the cavity faces the sound source.

3. The input device according to claim 1, wherein
the opening is disposed around the pen-tip section.

4. The input device according to claim 1, wherein
the sound source includes an actuator that generates vibrations or includes a speaker.

5. An information processing system comprising an information processing apparatus, and a pen-shaped input device,
the input device including:
a rod-shaped housing having a tip end and extending in an axial direction;
a pen-tip section that protrudes from the tip end of the housing;
a sound source inside the housing; and
a cavity having an opening at the tip end and extending along the axial direction of the housing, whereby the cavity outputs sound generated by the sound source from the opening to outside of the housing,
the information processing apparatus including a touchscreen that is operable in response to a touch with the pen-tip section of the input device,
the opening facing a surface of the touchscreen during a touch operation to the touchscreen with the pen-tip section.
